(19) United States
(12) Patent Application Publication
(10) Pub. No.: US 2020/0362163 A1
(43) Pub. Date: Nov. 19, 2020

(54) MATTE FINISH FOR PLASTICS

(71) Applicant: Ampacet Corporation, Tarrytown, NY (US)

(72) Inventor: Jared A. TATUM, Brazil, IN (US)

(21) Appl. No.: 15/930,624

(22) Filed: May 13, 2020

Related U.S. Application Data
(60) Provisional application No. 62/848,194, filed on May 15, 2019.

(51) Int. Cl. C08L 67/02; B65D 1/02

(52) U.S. Cl. CPC C08L 67/02; B65D 1/0207; C08L 2312/00; C08L 2310/00; B29C 49/10; C08L 2205/035; C08L 2205/14; C08L 2203/30; C08L 2203/10; C08L 2205/025

(57) ABSTRACT

Compositions and methods for producing a matte finish for plastics are disclosed herein. An exemplary thermoplastic article having a matte, printable surface is made of a thermoplastic resin and a thermoplastic additive composition having cross-linked silicone microparticles in a carrier resin. The composition can have 2.5% to 7.5% cross-linked silicone microparticles in a carrier resin, for example polyethylene terephthalate (PET). The cross-linked silicone microparticles have a particle size of about 2 μm to about 15 μm. The disclosed thermoplastic article can have a surface texture that is soft and smooth and a gloss level of less than 15 gloss units.

### CROSS-REFERENCE TO RELATED APPLICATIONS

This application claims benefit of and priority to U.S. Provisional Patent Application No. 62/848,194 filed May 15, 2019 which is incorporated by reference in its entirety.

### TECHNICAL FIELD OF THE INVENTION

This invention is generally related to compositions and methods of creating a matte appearance for plastics.

### BACKGROUND OF THE INVENTION

In the currently saturated consumer market, producers of consumer goods must compete for available shelf space in retail businesses and advertisement space online. Therefore, the consumer product must be able to quickly catch the eye of the consumer. The outer appearance of the product, including its shape, color, texture, and labeling is the first impression for the consumer. Producers of consumer goods undertake considerable efforts to deliver a desired appearance to attract consumers to their products.

Most plastic materials produce a high gloss surface when molded. There are several benefits to achieving a matte finish on plastics, specifically plastic bottles and containers. It is easier to print directly onto a matte finish, which would eliminate the need for additional labels on plastic products or products packaged in plastic. Matte finishes are more aesthetically pleasing to some consumers, in both look and feel. In addition, matte finishes eliminate light reflection, making it easier to visualize branding on that product.

Currently, creating a matte finish on plastic consumables requires many additional steps outside of the normal production schedule. Additional production steps can be time consuming, require additional reagents and raw materials, and increase the cost of the product. PET bottles, for instance, require costly mold modifications that permanently alter the surface of tool steel to offer a similar textured surface. Another method of achieving a matte appearance on a PET bottle is through the use of a secondary process in which a coating is topically applied. The use of a secondary process is costly and time consuming, and bottle manufacturers prefer not to use this method. Therefore, there is a need for a more efficient method for producing a matte finish on plastic consumables that does not require changes to mold cavities or a secondary process.

It is an object of the invention to provide compositions and methods for producing a matte finish on plastic consumables.

### SUMMARY OF THE INVENTION

Compositions and methods for achieving a matte finish on plastics are disclosed herein. It is often desirable to have a matte finish on plastics for ease of printing directly onto the plastic, for aesthetic reasons, and for the elimination of light reflection off of the plastic article.

One embodiment provides a thermoplastic article having a matte, printable surface wherein the article is made of a thermoplastic resin and a thermoplastic additive composition having cross-linked silicone microparticles in a carrier resin. The composition can have 2.5% to 7.5% cross-linked silicone microparticles in a carrier resin, for example polyethylene terephthalate (PET). The cross-linked silicone microparticles have a particle size of about 2 μm to about 15 μm. The disclosed thermoplastic article can have a surface texture that is soft and smooth and a gloss level of less than 15 gloss units. The thermoplastic article can be a blow molded PET bottle or biaxially-oriented polyethylene terephthalate (BoPET).

In one embodiment, the thermoplastic composition used to make plastic articles can also include cross-linked acrylic copolymer microparticles. In such an embodiment, the article can include cross-linked silicone microparticles in an amount of about 2.5% to about 7.5% and cross-linked acrylic copolymer microparticles in an amount of about 6.25% to about 15%. The cross-linked acrylic copolymer microparticles can be crosslinked poly(methyl methacrylate) (PMMA) microparticles.

Also disclosed is a method of producing a matte finish for a blow molded PET bottle, by injection stretch blow molding a thermoplastic composition made of cross-linked silicone microparticles in polyethylene terephthalate (PET) to form a blow molded PET bottle having a matte finish. The thermoplastic composition can have 2.5% to 7.5% cross-linked silicone microparticles with a particle size of about 2 μm to about 15 μm. The thermoplastic composition can additionally include cross-linked acrylic copolymer microparticles, which can give the blow molded PET bottle a soft feel. The thermoplastic composition can include cross-linked silicone microparticles in an amount of about 2.5% to about 7.5% and cross-linked acrylic copolymer microparticles in an amount of about 6.25% to about 15%.

Another embodiment provides a blow-molded PET bottle having a matte finish including polyethylene terephthalate (PET), and an additive having about 2.5% to about 7.5% cross-linked silicone microparticles and about 6.25% to about 15% cross-linked acrylic copolymer microparticles in a carrier resin, wherein the blow-molded bottle has a gloss level of less than 15 gloss units.

### BRIEF DESCRIPTION OF THE DRAWINGS

FIG. 1A-1B are Kraft Paper styli results for Experiment 55 (FIG. 1A) and Experiment 56 (FIG. 1B).

FIG. 2A-2B are bottle styli results for Experiment 55 (FIG. 2A) and Experiment 56 (FIG. 2B).

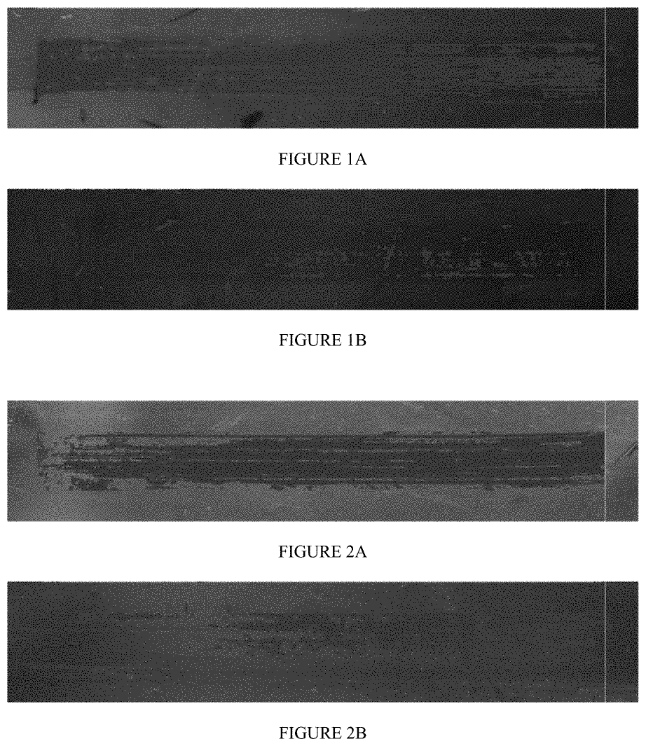

### DETAILED DESCRIPTION OF THE INVENTION

### I. Definitions

It should be appreciated that this disclosure is not limited to the compositions and methods described herein as well as the experimental conditions described, as such may vary. It is also to be understood that the terminology used herein is for the purpose of describing certain embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any compositions, methods and materials similar or equivalent to those described herein can be used in the practice or testing of the present invention. All publications mentioned are incorporated herein by reference in their entirety.

The use of the terms “a,” “an,” “the,” and similar referents in the context of describing the presently claimed invention (especially in the context of the claims) are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein.

Use of the term “about” is intended to describe values either above or below the stated value in a range of approx. +/−10%; in other embodiments the values may range in value either above or below the stated value in a range of approx. +/−5%; in other embodiments the values may range in value either above or below the stated value in a range of approx. +/−2%; in other embodiments the values may range in value either above or below the stated value in a range of approx. +/−1%. The preceding ranges are intended to be made clear by context, and no further limitation is implied. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

As used herein, “haze” refers to an optical effect caused by light scattering within a transparent polymer resulting in a cloudy or milky appearance. “Haze index” refers to the degree of light scattering within a polymer. Haze measurements can be made by using a hazemeter or a spectrophotometer.

“Dyne”, “dyne level”, and “dyne value” can be used interchangeably and refer to the measure of surface energy. Dyne can affect the adherence of inks or coatings to plastics or polymers. In a dyne test, wetting tension liquids are spread over a substrate to determine printability, coating layout, and heat sealability of treated films. There are three methods used to measure dyne levels: the dyne pen method, cotton swab applicator method, and the drawdown method. To achieve good wettability, the surface energy of the substrate needs to exceed the surface tension of the liquid. For proper ink wetting and adhesion, the ink needs to have at least a 5 dyne/cm lower surface energy than the substrate. Common plastics used in clear packaging have natural “dyne” levels of 34 to 40 dyne/cm.

As used herein, “gloss” refers to an optical property which describes how well a surface reflects light in specular direction when measured using a 45° Gloss Meter. “High gloss” refers to a gloss level greater than 50 gloss units, “medium gloss” refers to a gloss level between 25 gloss units and 50 gloss units, “low gloss” refers to a gloss level between 15 gloss units and 25 gloss units, and “matte effect” refers to a gloss level less than 15 gloss units.

“Polyethylene terephthalate” or “PET” is a thermoplastic polymer resin of the polyester family. PET is made from petroleum hydrocarbons, formed as a reaction between ethylene glycol, a colorless viscous hygroscopic liquid, and terephthalic acid, an organic compound. During the production process, PET polymerizes to form long molecular chains. PET is commonly used in fibers for clothing, containers for liquids and foods, manufacturing thermoforms, and extruded into photographic film and magnetic recording film.

Furthermore, “PET” also applies to any polyester that can be used to make a blow molded bottle and includes PET copolymers and blends. In general, the polyester polymers and copolymers may be prepared, for example, by melt phase polymerization involving the reaction of a diol with a dicarboxylic acid, or its corresponding diester. Various copolymers resulting from use of multiple diols and diacids may also be used.

Suitable dicarboxylic acids include those comprising from about 4 to about 40 carbon atoms. Specific dicarboxylic acids include, but are not limited to, terephthalic acid, isophthalic acid, naphthalene 2,6-dicarboxylic acid, cyclohexanedicarboxylic acid, cyclohexanediacetic acid, diphenyl-4,4′-dicarboxylic acid, 1,3-phenylenedioxydiacetic acid, 1,2-phenylenedioxydiacetic acid, 1,4-phenylenedioxydiacetic acid, succinic acid, glutaric acid, adipic acid, azelaic acid, sebacic acid, and the like. Specific esters include, but are not limited to, phthalic esters and naphthalic diesters.

These acids or esters may be reacted with an aliphatic diol preferably having from about 2 to about 24 carbon atoms, a cycloaliphatic diol having from about 7 to about 24 carbon atoms, an aromatic diol having from about 6 to about 24 carbon atoms, or a glycol ether having from 4 to 24 carbon atoms. Suitable diols include, but are not limited to, ethylene glycol, 1,4-butanediol, trimethylene glycol, 1,6-hexanediol, 1,4-cyclohexanedimethanol, diethylene glycol, resorcinol, 1,3-propanediol and hydroquinone.

A useful polyester is a crystallizable polyester with more than 85% of its acid units being derived from terephthalic acid. It is generally accepted that polyesters with greater than 15% comonomer modification are difficult to crystallize. Polyesters which would crystallize and have more than 15% comonomer content and polyesters which do not crystallize and/or have more than 15% comonomer content are included herein.

Polyfunctional comonomers can also be used, typically in amounts of from about 0.01 to about 3 mole percent. Suitable comonomers include, but are not limited to, trimellitic anhydride, trimethylolpropane, pyromellitic dianhydride (PMDA), and pentaerythritol. Polyester-forming polyacids or polyols can also be used. Blends of polyesters and copolyesters may also be useful.

As used herein, “masterbatch” refers to a solid product (normally of plastic, rubber, or elastomer) in which pigments or additives are optimally dispersed at high concentration in a carrier material. The carrier material is compatible with the main plastic in which it will be blended during molding, whereby the final plastic product obtains the color or properties from the masterbatch.

### II. Compositions and Methods for Achieving a Matte Finish for Plastics

Compositions and methods for achieving a matte finish for plastics are disclosed herein. It is often desirable to have a matte finish on plastics for ease of printing directly onto the plastic, for aesthetic reasons, and for the elimination of light reflection off of the plastic article. One embodiment provides a thermoplastic composition including cross-linked silicone microparticles in a carrier resin. Such a thermoplastic composition has low gloss properties when used in plastic articles. The thermoplastic composition can additionally include cross-linked acrylic copolymer microparticles. Such a thermoplastic composition has a “soft” feel in addition to the matte properties of the article made with thermoplastic composition including only cross-linked silicone microparticles. More details about the disclosed thermoplastic compositions are provided below.

A. Thermoplastic Composition

Thermoplastic compositions that have a low gloss or matte finish when extruded into plastic bottles are disclosed herein. The thermoplastic composition can include cross-linked silicone microparticles in a carrier resin. The cross-linked silicone microparticles can be any commercially available cross-linked silicone microparticles having average particle sizes ranging from about 2.0 μm to about 15.0 μm. In one embodiment, the cross-linked silicone microparticles can have an average particle size of 2, 3, 4, 5, 6, 7, 8, 9, 10, 11, 12, 13, 14, or 15 μm. In one embodiment, the thermoplastic composition is a masterbatch additive that is added to thermoplastic resin compositions.

Thermoplastic compositions that have a low gloss finish and a “soft” feel are also disclosed. In such an embodiment, the thermoplastic composition includes cross-linked silicone microparticles and cross-linked acrylic copolymer microparticles in a carrier resin. The cross-linked acrylic copolymer microparticles can be commercially available cross-linked acrylic copolymer microparticles, having average particle sizes ranging from about 2 μm to about 15 μm. In one embodiment, the cross-linked acrylic copolymer microparticles can have an average particle size of 2, 3, 4, 5, 6, 7, 8, 9, 10, 11, 12, 13, 14, or 15 μm. In one embodiment, the cross-linked acrylic copolymer microparticles are crosslinked poly(methyl methacrylate) (PMMA) microparticles.

Plastic for consumer goods is made primarily from one of the following thermoplastic resins, polyethylene terephthalate (PET), high-density polyethylene (HDPE), polyvinyl chloride (PVC), low-density polyethylene (LDPE), polypropylene (PP), and polystyrene (PS). In a preferred embodiment, the disclosed thermoplastic compositions include PET as the thermoplastic resin.

Without being bound to any one theory it is believed that gloss reduction occurs from inclusion of a second non-melting polymer due to a distinct separate phase formed by the added polymer, the size of which interacts with light such that reflectance is reduced and gloss is decreased. Therefore, the particle size is important to achieving the matte effect. In one embodiment, the cross-linked silicone microparticles and cross-linked acrylic copolymer microparticles have a particle size of 2 μm to 15 μm. The microparticles can have a particle size that is 2 μm, 2.5 μm, 3 μm, 3.5 μm, 4 μm, 4.5 μm, 5 μm, 5.5 μm, 6 μm, 6.5 μm, 7 μm, 7.5 μm, 8 μm, 8.5 μm, 9 μm, 9.5 μm, 10 μm, 10.5 μm, 11 μm, 11.5 μm, 12 μm, 12.5 μm, 13 μm, 13.5 μm, 14 μm, 14.5 μm, or 15 μm. In one embodiment both the cross-linked silicone microparticles and cross-linked acrylic copolymer microparticles have the same particle size. In another embodiment, the cross-linked silicone microparticles and cross-linked acrylic copolymer microparticles have different particle sizes.

The amount of cross-linked silicone microparticles and cross-linked acrylic copolymer microparticles in the composition is critical to achieving the matte effect. In one embodiment, the thermoplastic composition can have 2.5% to 7.5% crosslinked silicone microparticles. The thermoplastic composition can have 2.5%, 2.75%, 3%, 3.25%, 3.5%, 3.75%, 4%, 4.25%, 4.5%, 4.75%, 5%, 5.25%, 5.5%, 5.75%, 6%, 6.25%, 6.5%, 6.75%, 7%, 7.25%, or 7.5% crosslinked silicone microparticles. In one embodiment, the thermoplastic composition can have 6.25% to 15% crosslinked acrylic copolymer microparticles. The thermoplastic composition can have 6.25%, 6.5%, 6.75%, 7%, 7.25%, 7.5%, 7.75%, 8%, 8.25%, 8.5%, 8.75%, 9%, 9.25%, 9.5%, 9.75%, 10%, 10.25%, 10.5%, 10.75%, 11%, 11.25%, 11.5%, 11.75%, 12%, 12.25%, 12.5%, 12.75%, 13%, 13.25%, 13.5%, 13.75%, 14%, 14.25%, 14.5%, 14.75%, or 15% crosslinking acrylic copolymer microparticles.

In one embodiment, a matte or low-gloss effect can be achieved in polyethylene terephthalate (PET) bottles.

B. PET Bottles with a Matte Finish

The disclosed thermoplastic compositions can be used to manufacture blow-molded PET bottles with a low gloss appearance, with or without a soft feel.

In one embodiment, a masterbatch can be prepared using one of the disclosed thermoplastic compositions. In one embodiment, the masterbatch can be made on a twin screw lab extruder operating under typical processing conditions for PET. Loading levels of about 40% to about 50% can be used.

The masterbatch can then be used to make plastic bottles. In one embodiment, the masterbatch is added to additional PET resin before being formed into a plastic bottle. Plastic bottles can be molded using various methods known in the art. Methods of molding plastic into bottles include but are not limited to injection molding, blow molding, compression molding, injection stretch blow molding, extrusion molding, and thermoforming. In a preferred embodiment, bottles are formed by PET injection stretch blow molding machine. Bottles can be formed using a standard high polish mold. In one embodiment, the plastic bottles are PET plastic bottles.

The disclosed matte plastic bottles and containers can be used for the following including but not limited to water, liquid soaps, shampoos, conditioners, and lotions, motor oil, milk, yogurts, soft drinks, juices, and salad dressings.

In one embodiment, the disclosed matte PET bottles can have gloss level of less than 15 gloss units. In another embodiment, the disclosed matte PET bottles can have a gloss level of between 15 gloss units and 25 gloss units.

C. Mar Resistant PET

In another embodiment, the disclosed thermoplastic compositions with low gloss or matte finish have improved mar resistance, compared to thermoplastic compositions without the low gloss or matte finish additives. PET scuff is a longstanding problem in the industry and the disclosed low gloss/matte additive demonstrates measurable improvements in blown exhibits. In one embodiment, resistance to marring, as measured by an abrasion test, is improved by at least 20%. In another embodiment, the disclosed thermoplastic compositions show improvements in scuff resistance of the preforms.

D. Biaxially-Oriented Polyethylene Terephthalate

In another embodiment, the thermoplastic compositions that have a low gloss or matte finish can be made into biaxially-oriented polyethylene terephthalate (BoPET). BoPET is a polyester film made from stretched polyethylene terephthalate (PET). BoPET is used for its high tensile strength, chemical and dimensional stability, transparency, and electrical insulation.

BoPET can be used to produce flexible packaging and food contact applications, such as lids for fresh or frozen meals and dairy products, roasting bags; covering over paper, such as overlays on maps, protective covering over buttons or badges, material for bagging and storing archived materials, and protective coverings for important documents such as medical records; insulating material, such as electrical insulating material, insulation for houses and tents, emergency blankets and spacesuits, light insulation for indoor gardening, fire shelters, and sock and glove liners; solar, marine and aviation applications, such as solar sails, solar curtains, high performance sails for sailboats, hang gliders, paragliders, and kites, and reflector material for solar cooking stoves; science applications, such as solar filters, light diaphragm material for separating gases, beamsplitter in Fourier transform infrared spectroscopy, coating around hematocrit tubes, insulating material for a cryocooler radiation shield, and window materials to confine gas in detectors and targets in nuclear physics; and electronic and acoustic applications, such as carriers for flexible printed circuits, diaphragm material in headphones, electrostatic loudspeakers and microphones, banjo and drumheads, magnetic recording tapes and floppy disks, dielectrics in foil capacitors.

In one embodiment, the disclosed matte BoPET has a gloss level of less than 15 gloss units. In another embodiment, the disclosed matte BoPET can have a gloss level of between 15 gloss units and 25 gloss units.

### EXAMPLES

### Example 1. Matte and Soft Finish for Molded PET Bottles

Materials and Methods

Masterbatches of the crosslinked bead additives were made on a twin screw lab extruder operating under typical processing conditions for PET. Loading levels of 40-50% were used. Masterbatches containing the silicone gum grades were also made but with a loading level of around 20%. Bottles were made on a PET injection stretch blow molding machine using a standard high polish mold. Light transmission and haze index were measured using the ASTM Standard Test Method for Haze and Luminous Transmittance of Transparent Plastics (ASTM D1003). Gloss was measured using the ASTM Standard Test Method for Specular Gloss of Plastic Films and Solid Plastics (ASTM D2457). Gloss was measured at a 45° angle on the bottles with a Microgloss gloss measuring instrument. Gloss was also assessed visually. The soft feel effect was assessed subjectively by a panel who examined the tactile properties of the bottles.

Results:

Table 1 provides a comprehensive list (experiments 1-62) of all the formulations evaluated. Table 1 reports compositions, gloss as measured in gloss units in the Glossometer, gloss as characterized visually, and the soft feel of the bottles.

Experiments 1-11 show the effects of increasing the amount of commercially available crosslinked silicone microparticles (average particle size 4.5 μm) on the gloss and feel of bottles. Adding even a small amount, between 0.5% and 1.5%, of the crosslinked silicone microparticles changes the gloss and feel of the bottles. Gloss becomes lower and the feel of the bottles changes from a “hard plastic” appearance to a smooth and slippery feel. At loadings above 5% a matte effect, defined visually and in gloss measurements of 15 gloss units or less, is achieved. Experiments 6-11 are preferable formulations with regard to achieving a matte effect only. Even with high amounts of the crosslinked silicone microparticles, the feel of the bottles is considered smooth and slippery, but not soft.

Experiments 12-21 show the effects of using a commercially available crosslinked acrylic copolymer microparticles (average particle size 8 μm) alone or in combination with crosslinked silicone microparticles (average particle size 4.5 μm). When using the crosslinked acrylic copolymer microparticles alone (Experiments 12 and 13) the feel is noted as soft but not smooth. Gloss is not nearly as low as when crosslinked silicone microparticles (average particle size 4.5 μm) was used, and the bottle texture is noted as feeling rubbery. When a combination of crosslinked acrylic copolymer microparticles and crosslinked silicone microparticles is used, a matte and soft effect is achieved (Experiments 18-21). In the bottles from Experiments 18-21 the gloss is less than 15 gloss units and the feel of the bottles is soft and smooth.

Experiments 22-35 show the effects of using a different grade of crosslinked acrylic copolymer microparticles (average particle size 8 μm) alone and in combination with the crosslinked silicone microparticles (average particle size 4.5 μm) and crosslinked acrylic copolymer microparticles (average particle size 8 μm). In some of the experiments a soft feel is achieved, but gloss below 15% is not reached.

Experiments 36-42 show the effects of using commercially available silicone gum alone and in conjunction with each of the crosslinked acrylic copolymer microparticles (average particle size 8 μm). Using that grade of silicone gum did not produce a matte or soft effect.

Experiments 43 and 44 show the effects of using another commercially available modified silicone gum. Using this grade of silicone also did not produce a matte or soft effect.

Experiments 45 and 46 show the effects of using a commercially available thermoplastic polyolefin (TPO) and HDPE resins. These resins did not produce a matte or soft effect even though the thermoplastic polyolefin (TPO) is known to product a soft touch effect in polyolefins

TABLE 1
Gloss and tactile “feel” properties of various compositions.

| | | | 8 μm | | | | | | | | | | | |
|---|---|---|---|---|---|---|---|---|---|---|---|---|---|---|
| | | 8 μm | Cross- | | | | | | | | | | | |
| | 4.5 μm | Cross- | linked | | | | | | | | | | | |
| | Cross- | linked | Acrylic | | | | | | | | | | | |
| Exp | Linked | Acrylic | CoPolymer | Silicone | Silicone | | | | | | | | Gloss- | |
| # | Silicone | CoPolymer | 2 | Gum | Gum - 2 | TPO | HDPE | TALC | TiO2 | CB | PETG | GU | Visual | Feel |
| 1 | | | | | | | | | | | | 100.0 | High | Hard plastic |
| | | | | | | | | | | | | | Gloss | |
| 2 | 0.50 | | | | | | | | | | | 38.8 | Medium | Smooth and |
| | | | | | | | | | | | | | Gloss | Less Slippery |
| | | | | | | | | | | | | | | than 6 |
| 3 | 1.00 | | | | | | | | | | | 40.1 | Medium | Smooth and |
| | | | | | | | | | | | | | Gloss | Slippery but not |
| | | | | | | | | | | | | | | soft |
| 4 | 1.50 | | | | | | | | | | | 42.4 | Medium | Smooth and |
| | | | | | | | | | | | | | Gloss | Slippery but not |
| | | | | | | | | | | | | | | soft |
| 5 | 2.50 | | | | | | | | | | | 17.1 | Low | Smooth and |
| | | | | | | | | | | | | | Gloss | Less slippery |
| | | | | | | | | | | | | | | than 3 |
| 6 | 5.00 | | | | | | | | | | | 9.7 | Matte | Smooth and |
| | | | | | | | | | | | | | | Slippery but not |
| | | | | | | | | | | | | | | soft |
| 7 | 5.50 | | | | | | | | | | | 9.8 | Matte | Smooth and |
| | | | | | | | | | | | | | | Slippery but not |
| | | | | | | | | | | | | | | soft |
| 8 | 6.00 | | | | | | | | | | | 14.8 | Matte | Smooth and |
| | | | | | | | | | | | | | | Slippery but not |
| | | | | | | | | | | | | | | soft |
| 9 | 6.50 | | | | | | | | | | | 9.2 | Matte | Smooth and |
| | | | | | | | | | | | | | | Slippery but not |
| | | | | | | | | | | | | | | soft |
| 10 | 7.00 | | | | | | | | | | | 8.2 | Matte | Smooth and |
| | | | | | | | | | | | | | | Slippery but not |
| | | | | | | | | | | | | | | soft |
| 11 | 7.50 | | | | | | | | | | | 9.7 | Matte | Smooth and |
| | | | | | | | | | | | | | | Slippery but not |
| | | | | | | | | | | | | | | soft |
| 12 | | 7.50 | | | | | | | | | | 35.6 | Medium | Soft Feel |
| | | | | | | | | | | | | | Gloss | |
| 13 | | 15.00 | | | | | | | | | | 20.3 | Low | Softer than 2, |
| | | | | | | | | | | | | | Gloss | but not as |
| | | | | | | | | | | | | | | smooth |
| 14 | 0.50 | 7.50 | | | | | | | | | | 28.8 | Medium | Soft-and slightly |
| | | | | | | | | | | | | | Gloss | smooth |
| 15 | 1.00 | 7.50 | | | | | | | | | | 19.7 | Low | Soft and |
| | | | | | | | | | | | | | Gloss | Smoother than |
| | | | | | | | | | | | | | | 8 |
| 16 | 1.50 | 7.50 | | | | | | | | | | 17.8 | Low | Soft and |
| | | | | | | | | | | | | | Gloss | Smooth Feel |
| 17 | 1.50 | 15.00 | | | | | | | | | | 16.2 | Low | Soft and |
| | | | | | | | | | | | | | Gloss | Smooth Feel |
| 18 | 2.50 | 7.50 | | | | | | | | | | 13.9 | Matte | Soft and |
| | | | | | | | | | | | | | | Smooth Feel |
| 19 | 2.50 | 15.00 | | | | | | | | | | 14.1 | Matte | Soft and |
| | | | | | | | | | | | | | | Smooth Feel |
| 20 | 6.25 | 6.25 | | | | | | | | | | 10.8 | Matte | Soft and |
| | | | | | | | | | | | | | | Smooth Feel |
| 21 | 7.50 | 7.50 | | | | | | | | | | 8.8 | Matte | Soft and |
| | | | | | | | | | | | | | | Smooth Feel |
| 22 | | | 7.50 | | | | | | | | | 46.9 | Medium | Soft, but not as |
| | | | | | | | | | | | | | Gloss | soft as 2 |
| 23 | | | 15.00 | | | | | | | | | 29.0 | Medium | Softer than 12, |
| | | | | | | | | | | | | | Gloss | but still less |
| | | | | | | | | | | | | | | than 2 |
| 24 | | 2.50 | 12.50 | | | | | | | | | 27.5 | Medium | Soft Feel |
| | | | | | | | | | | | | | Gloss | |
| 25 | | 5.00 | 10.00 | | | | | | | | | 21.5 | Medium | Soft Feel |
| | | | | | | | | | | | | | Gloss | |
| 26 | | 7.50 | 7.50 | | | | | | | | | 26.1 | Medium | Soft and |
| | | | | | | | | | | | | | Gloss | Smooth Feel |
| 27 | | 12.50 | 2.50 | | | | | | | | | 17.4 | Low | Soft Feel |
| | | | | | | | | | | | | | Gloss | |
| 28 | 1.50 | | 7.50 | | | | | | | | | 55.4 | High | Slightly Soft |
| | | | | | | | | | | | | | Gloss | |
| 29 | 2.50 | | 7.50 | | | | | | | | | 64.1 | High | Slightly Soft |
| | | | | | | | | | | | | | Gloss | |
| 30 | 1.50 | | 15.00 | | | | | | | | | 38.2 | Medium | Soft and |
| | | | | | | | | | | | | | Gloss | Smooth Feel |
| 31 | 2.50 | | 15.00 | | | | | | | | | 43.7 | Medium | Soft and |
| | | | | | | | | | | | | | Gloss | Smooth Feel |
| 32 | 1.50 | 2.50 | 12.50 | | | | | | | | | 54.6 | High | Soft Feel |
| | | | | | | | | | | | | | Gloss | |
| 33 | 2.50 | 5.00 | 3.75 | | | | | | | | | 100.0 | High | Slightly Soft |
| | | | | | | | | | | | | | Gloss | |
| 34 | 2.50 | 5.00 | 5.00 | | | | | | | | | 33.1 | Medium | Soft and |
| | | | | | | | | | | | | | Gloss | Smooth Feel |
| 35 | 2.50 | 7.50 | 7.50 | | | | | | | | | 17.1 | Low | Soft and |
| | | | | | | | | | | | | | Gloss | Smooth Feel |
| 36 | | | | 0.30 | | | | | | | | 100.0 | High | No noticeable |
| | | | | | | | | | | | | | Gloss | tactile change |
| | | | | | | | | | | | | | | from 1 |
| 37 | | 3.75 | 6.25 | 2.50 | | | | | | | | 49.1 | Medium | Soft Feel |
| | | | | | | | | | | | | | Gloss | |
| 38 | | | 10.00 | 2.50 | | | | | | | | | | Bottles could |
| | | | | | | | | | | | | | | not be made |
| 39 | | 10.00 | | 5.00 | | | | | | | | 46.6 | Medium | Soft Feel |
| | | | | | | | | | | | | | Gloss | |
| 40 | | | 10.00 | 5.10 | | | | | | | | 36.2 | Medium | Soft Feel |
| | | | | | | | | | | | | | Gloss | |
| 41 | | 6.25 | | 6.25 | | | | | | | | 53.8 | High | Slightly Soft |
| | | | | | | | | | | | | | Gloss | |
| 42 | | | | 7.50 | | | | | | | | 100.0 | High | Bottle looked |
| | | | | | | | | | | | | | Gloss | metallic |
| 43 | | | | | 0.20 | | | | | | | 100.0 | High | No noticeable |
| | | | | | | | | | | | | | Gloss | tactile change |
| | | | | | | | | | | | | | | from 1 |
| 44 | | | | | 1.00 | | | | | | | 99.7 | High | No noticeable |
| | | | | | | | | | | | | | Gloss | tactile change |
| | | | | | | | | | | | | | | from 1 |
| 45 | | | | | | 22.43 | | | | | | 96.4 | High | No noticeable |
| | | | | | | | | | | | | | Gloss | tactile change |
| | | | | | | | | | | | | | | from 1 |
| 46 | | | | 7.50 | | | 13.68 | 1.25 | | | | 74.8 | High | No noticeable |
| | | | | | | | | | | | | | Gloss | tactile change |
| | | | | | | | | | | | | | | from 1 |
| 47 | 0.80 | | | | | | | | | | | | | |
| 48 | 2.00 | | | | | | | | | | | | | |
| 49 | 4.00 | | | | | | | | | | | | | |
| 50 | 6.00 | | | | | | | | | | | | | |
| 51 | | | | | | | | | 1.96 | | | | | |
| 52 | 3.00 | 4.50 | | | | | | | 1.96 | | | | | |
| 53 | 4.80 | 7.20 | | | | | | | 1.96 | | | | | |
| 54 | 6.00 | 9.00 | | | | | | | 1.96 | | | | | |
| 55 | | | | | | | | | | 0.75 | | | | |
| 56 | 4.80 | | | | | | | | | 0.75 | | | | |
| 57 | | | | | | | | | | | 10.00 | | | |
| 58 | 0.80 | | | | | | | | | | 10.00 | | | |
| 59 | 2.00 | | | | | | | | | | 10.00 | | | |
| 60 | 4.00 | | | | | | | | | | 10.00 | | | |
| 61 | 3.00 | 4.50 | | | | | | | | | 10.00 | | | |
| 62 | 5.00 | 7.50 | | | | | | | | | 10.00 | | | |

Further testing was done on injection-stretch blow molded (ISBM) bottles. Tables 2 and 3 show light transmission (%), haze index, gloss, and surface energy (dyne) of natural (no color) and white colored bottles. Three bottles were tested. With an increasing amount of matte/soft touch additives, the light transmission, haze index and gloss all decreased, and the surface energy increased. Light transmission and haze index were much lower for the white bottles due to the presence of white pigment. These test results confirm that the presence of the matte/soft touch additives provides a “delustering” of the PET.

Table 4 shows the effects of the matte/soft touch additives on coefficient of friction of PET cast films. Increasing the amount of matte/soft touch additives in the film substantially decrease coefficient of friction. A reduced coefficient of friction would be expected for bottles as well

TABLE 2
Matte Natural PET bottle properties

| | Gauge (mil) | | | LTM % ASTM D1003 | | | Haze index ASTM D1003 | | | Gloss ASTM D 2457 45° | | | |
|---|---|---|---|---|---|---|---|---|---|---|---|---|---|
| Sample # | 1 | 2 | 3 | 1 | 2 | 3 | 1 | 2 | 3 | 1 | 2 | 3 | Dyne |
| Experiment | 25.0 | 21.2 | 26.0 | 93.8 | 93.9 | 93.9 | 1.5 | 1.1 | 1.2 | >100 | >100 | >100 | 34 |
| 1 | | | | | | | | | | | | | |
| Experiment | 10.0 | 23.5 | 25.7 | 86.1 | 78.1 | 88.2 | 78.8 | 73.0 | 78.8 | 54.2 | 48.4 | 47.0 | 34 |
| 47 | | | | | | | | | | | | | |
| Experiment | 22.2 | 24.7 | 21.3 | 62.3 | 62.1 | 57.7 | 61.1 | 61.0 | 56.7 | 38.5 | 33.1 | 43.3 | 36 |
| 48 | | | | | | | | | | | | | |
| Experiment | *17.6 | 17.1 | 16.1 | 76.6 | 76.3 | 64.9 | 74.7 | 74.9 | 62.9 | 11.3 | 21.0 | 19.6 | 38 |
| #49 | | | | | | | | | | | | | |
| Experiment | 19.2 | 26.3 | 28.1 | 55.5 | 54.9 | 43.9 | 54.9 | 53.7 | 42.9 | 12.8 | 15.7 | 11.8 | 40 |
| #50 | | | | | | | | | | | | | |

LTM = light transmission; Gloss = Gloss index; Dyne = A measure of surface energy used for label and print adhesion. These are untreated, raw surface energies. In other words, no corona treatment was used.

TABLE 3
Matte White PET bottle properties

| | Gauge (mil) | | | LTM % ASTM D1003 | | | Haze index ASTM D1003 | | | Gloss ASTM D 2457 45° | | | |
|---|---|---|---|---|---|---|---|---|---|---|---|---|---|
| Sample # | 1 | 2 | 3 | 1 | 2 | 3 | 1 | 2 | 3 | 1 | 2 | 3 | Dyne |
| Experiment | 26.3 | 26.4 | 15.7 | 12.1 | 10.1 | 15.7 | 11.6 | 9.7 | 15.2 | 64.8 | 63.2 | 61.8 | 34 |
| 51 | | | | | | | | | | | | | |
| Experiment | 22.5 | 20.8 | 24.5 | 9.7 | 8.2 | 10.5 | 9.8 | 8.0 | 9.4 | 22.2 | 18.7 | 18.7 | 40 |
| 52 | | | | | | | | | | | | | |
| Experiment | 22.5 | 22.7 | 21.5 | 9.7 | 9.8 | 6.4 | 9.9 | 9.4 | 6.4 | 12.2 | 12.0 | 10.8 | 40 |
| 53 | | | | | | | | | | | | | |
| Experiment | 23.6 | 22.6 | 30.6 | 5.7 | 9.6 | 7.2 | 5.7 | 9.4 | 7.0 | 8.9 | 10.8 | 12.6 | 42 |
| 54 | | | | | | | | | | | | | |

LTM = light transmission; Gloss = Gloss index; Dyne = A measure of surface energy used for label and print adhesion. These are untreated, raw surface energies. No corona treatment was employed.

TABLE 4
PET Cast Film Properties.

| | | LTM % | Gloss ASTM D | |
|---|---|---|---|---|
| Sample # | Gauge (mil) | ASTM D1003 | 2457 45° | Kinetic CoF |
| Experiment | 4.50 | 94.9 | >100 | 0.33 |
| 57 | | | | |
| Experiment | 7.75 | 93.7 | 66.8 | 0.23 |
| 58 | | | | |
| Experiment | 8.00 | 91.3 | 56.0 | 0.23 |
| 59 | | | | |
| Experiment | 7.00 | 82.9 | 48.4 | 0.21 |
| 60 | | | | |
| Experiment | 7.00 | 77.4 | 31.7 | 0.17 |
| 61 | | | | |
| Experiment | 7.30 | 69.3 | 22.0 | 0.18 |
| 62 | | | | |

### Example 2. Mar Resistance of Matte and Soft Finished Molded PET Bottles

Materials and Methods

Mar testing was conducted on control bottles containing no additive (Experiment 55) and on bottles containing the matte/soft touch additive (Experiment 56). Rectangular test sections were cut from the bottles and mounted to a stiff backing plate to hold the specimens flat for testing. Kraft paper (cardboard) test styli were prepared by mounting ten millimeter circles of Kraft paper (cardboard) onto circular stainless steel backing plates. Similarly, bottle styli were prepare by cutting 7×7 mm bottle sections and mounting onto square stainless steel backing plates. Mar testing was conducted on a Scratch 4 Machine from Surface Machine Systems. In this test the styli were slid across rectangular test section at a velocity of 50 mm/s for a length of 100 mm under a progressively increasing load where the starting load was 1 newton and the ending load was 100 newtons. Two sliding passes were made for each test.

The sliding action of the styli left a mar damage field of increasing intensity, due to the progressively increased load, along the test specimen. Mar damage was assessed quantitatively by an image analysis method. Tested samples were placed into a black box and illuminated with fluorescent lighting. Images were captured, digitized, and analyzed by special tribometric software from Surface Machine Systems. The contrast of each pixel in the mar damage field was measured and compared to base contrast of pixels outside the damage field. If the contrast differed by greater than 3%, that pixel was counted as a “visible pixel”. The level of marring was calculated as the percentage of visible pixels in the mar damage field.

Results:

For the Kraft paper styli the percentage of visible pixels was 54% in the PET control bottle and 14% in the bottle with the matte/soft touch additive. This result indicated a significant reduction in marring on the bottle that contained the matte/soft touch additive.

For the bottle styli the percentage of visible pixels was 67% in the control bottle and 44% in the bottle with the of the matte/soft touch additive. This result indicated a significant reduction in marring on the bottle that contained the matte/soft touch additive.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

All references cited herein are incorporated by reference in their entirety. The present invention may be embodied in other specific forms without departing from the spirit or essential attributes thereof and, accordingly, reference should be made to the appended claims, rather than to the foregoing specification, as indicating the scope of the invention.

We claim:

1. A thermoplastic article having a matte, printable surface comprising,
a thermoplastic resin, and
a thermoplastic additive comprising cross-linked silicone microparticles in a carrier resin, wherein the thermoplastic article has a gloss level of less than 15 gloss units.

2. The article of claim 1, wherein the thermoplastic additive comprises 2.5% to 7.5% cross-linked silicone microparticles.

3. The article of claim 1, wherein the carrier resin is polyethylene terephthalate (PET).

4. The article of claim 1, wherein the cross-linked silicone microparticles have a particle size of about 2 μm to about 15 μm.

5. The article of claim 1, wherein the article has a surface texture that is soft and smooth.

6. The article of claim 1, wherein the article is a blow molded PET bottle or polyester copolymers or blends.

7. The article of claim 1, wherein the article is biaxially-oriented polyethylene terephthalate (BoPET).

8. The article of claim 1, further comprising cross-linked acrylic copolymer microparticles.

9. The article of claim 8, wherein the cross-linked silicone microparticles are present in an amount of about 2.5% to about 7.5% and the cross-linked acrylic copolymer microparticles are present in an amount of about 6.25% to about 15%.

10. The article of claim 8, wherein the cross-linked acrylic copolymer microparticles are crosslinked poly(methyl methacrylate) (PMMA) microparticles.

11. The article of claim 1, wherein the article is mar resistant.

12. A method of producing a matte finish for a blow molded polyester bottle, comprising, injection stretch blow molding a thermoplastic composition comprising cross-linked silicone microparticles in polyethylene terephthalate (PET) to form a blow molded PET bottle having a matte finish.

13. The method of claim 12, wherein the thermoplastic composition comprises 2.5% to 7.5% cross-linked silicone microparticles.

14. The method of claim 12, wherein the silicone microparticles have a particle size of about 2 μm to about 15 μm.

15. The method of claim 12, wherein the thermoplastic composition further comprises cross-linked acrylic copolymer microparticles.

16. The method of claim 15, wherein the thermoplastic composition comprises cross-linked silicone microparticles in an amount of about 2.5% to about 7.5% and cross-linked acrylic copolymer microparticles in an amount of about 6.25% to about 15%.

17. A method of producing a mar resistant surface for a blow molded Polyester bottle, comprising, injection stretch blow molding a thermoplastic composition comprising cross-linked silicone microparticles in polyethylene terephthalate (PET) to form a blow molded PET bottle having resistance to marring.

18. The method of claim 17, wherein resistance to marring, as measured by an abrasion test, is improved by at least 20% compared to a PET bottle produced without a thermoplastic composition comprising cross-linked silicone microparticles in polyethylene terephthalate (PET).

19. The article of claim 1, wherein the article is a blow-molded PET bottle, the thermoplastic resin comprises polyethylene terephthalate (PET), and the additive comprises about 2.5% to about 7.5% cross-linked silicone microparticles and about 6.25% to about 15% cross-linked acrylic copolymer microparticles in a carrier resin.

20. The bottle of claim 19, wherein the cross-linked silicone microparticles and cross-linked acrylic copolymer microparticles have a particle size of about 2 μm to about 15 μm.
